(19) United States
(12) Patent Application Publication
(10) Pub. No.: US 2023/0271396 A1
(43) Pub. Date: Aug. 31, 2023

(54) DISPENSERS WITH BEARINGS FOR TENSION ACTIVATED EXTENDABLE SHEETS

(71) Applicants: Thomas R.J. Corrigan, St. Paul, MN (US); Patrick R. Fleming, Lake Elmo, MN (US); Jacob T. Lusson, Richfield, MN (US); James E. Nash, Bloomington, MN (US)

(72) Inventors: Thomas R.J. Corrigan, St. Paul, MN (US); Patrick R. Fleming, Lake Elmo, MN (US); Jacob T. Lusson, Richfield, MN (US); James E. Nash, Bloomington, MN (US)

(21) Appl. No.: 18/017,280

(22) PCT Filed: Jul. 28, 2021
(86) PCT No.: PCT/IB2021/056869

§ 371 Date: Jan. 20, 2023

Related U.S. Application Data
(60) Provisional application No. 63/189,332, filed on May 17, 2021.
(60) Provisional application No. 63/077,963, filed on Sep. 14, 2020.
(60) Provisional application No. 63/058,140, filed on Jul. 29, 2020.

(51) Int. Cl. B31D 5/00; B65H 16/00; B65H 23/06

(52) U.S. Cl. CPC B31D 5/0065; B65H 16/005; B65H 23/06; B31D 2205/0023; B31D 2205/0047

(57) ABSTRACT

Dispenser with bearings for dispensing a roll of tension activated expandable sheet material, as well as methods for using the same.

### BACKGROUND

US20190248092 discloses a device for expanding and dispensing expandable slit sheet paper comprising a means for pressing an end region of an interior core member of a paper roll and for applying a frictional rotational resistance to an end region of the interior core member.

US20190193366 discloses an expansion device with an unexpanded slit sheet roll that is wound on a paper core that is longer than the width of the slit paper roll. The device exerts a downward pressure on a rod member on which the paper core is placed, which in turn creates the friction required to enable the roll to unwind and simultaneously expand.

WO201975371 discloses a combined shipping and expansion device for shipping a roll of unexpanded slit sheet material. The device includes a friction member applying pressure against a core on which the roll is wound.

### BRIEF DESCRIPTION OF THE DRAWINGS

FIG. 1 is a drawing of an exemplary low friction dispenser without a roll of tension activated expandable sheet material;

FIG. 2 is the exemplary low friction dispenser of FIG. 1 with a roll of tension activated expandable sheet material loaded thereon;

FIG. 3 is a drawing of a different low friction dispenser; and

FIG. 4 is another view of the low friction dispenser of FIG. 3.

FIG. 5 is a drawing of another exemparly low friction dispenser

### DETAILED DESCRIPTION

In this disclosure, the terms “a” or “an” are often used for convenience, but it should be understood that such terms include both the singular and the plural unless the singular alone is expressly called for or necessary by context.

Terms of high frequency, such as “usual,” “usually,” “often,” “frequent,” “frequently,” “common,” “commonly,” and the like, are used to describe features that are used most often in the context of the disclosure. Unless the prior art is specifically referred to, these terms are not used to indicate that any feature or item is present in the prior art, much less that it is common or well-known.

“Paper” as used herein refers to woven or non-woven sheet-shaped products or fabrics (which may be folded, and may be of various thicknesses) made from cellulose (particularly fibers of cellulose, (whether naturally or artificially derived)) or otherwise derivable from the pulp of plant sources such as wood, corn, grass, rice, and the like. Paper includes products made from both traditional and non-traditional paper making processes, as well as materials of the type described above that have other types of fibers embedded in the sheet, for example, reinforcement fibers. Paper may have coatings on the sheet or on the fibers themselves. Examples of non-traditional products that are “paper” within the context of this disclosure include the material available under the trade designation TRINGA from PAPTIC (Espoo, Finland), and sheet forms of the material available under the trade designation SULAPAC.

In this disclosure, “Minimum Pull Force Per Unit Width” is determined according to the test method described herein. Unless otherwise specified, the width refers to the width of the tension activated expandable sheet material, that is, the dimension perpendicular to the direction in which the tension activated expandable sheet material is wound.

Throughout this disclosure, the term “coefficient of friction” refers exclusively to the static coefficient of friction as measured according to ASTM D1894. Because the roll is under the greatest tension at the time that it first begins to rotate, expandable sheet materials are at greatest danger of tearing when the roll first starts rotating (they can, however, tear at other times). Thus, the static coefficient of friction is an appropriate measurement when considering whether a tension activated expandable sheet material will tear upon unwinding of the roll.

This disclosure recognizes problems related to dispensers for rolls of tension activated expandable sheet material, such as a slit paper rolls as well as problems associated with dispensing such tension activated expandable sheet materials. Previous dispensers are configured to increase the resistance that is applied to the roll when a free end is pulled so that the slit paper will expand as the roll unwinds. However, for some configurations of tension activated expandable sheet material, including some slit paper sheets, the resistance provided by prior art dispensers is so high that the force needed to unwind the tension activated expandable sheet material can tear the material while it is being dispensed. In some cases, even the resistance that is obtained because of friction between the roll or core and the dispenser is sufficient that the tension activated expandable sheet material may undesirably tear while it is being dispensed. Thus, this disclosure recognizes that it can be desirable to make a dispenser that lowers the friction and other resistive forces on the roll. This disclosure also recognizes that doing so allows for a dispenser that desirably provides a resistance that is high enough to expand tension activated expandable sheet materials as they unwind from a roll, but low enough to avoid unwanted tearing during unwinding.

Briefly, a solution to this problem lies in the use of a device that includes a roll of tension activated expandable sheet material having a plurality of slits, the roll optionally being disposed around an interior core member, a first support member and optionally an opposing second support member, as well as a first set of one or more bearings associated with at least the first support member and optionally a second set of one of more bearings associated with at least the second support member, wherein the roll of tension activated expandable sheet material or the interior core of the roll is in communication with the first set of bearings and, optionally, the second set of bearings. The roll or interior core can be in direct communication with the first set of bearings and optionally the second set of bearings, such as by contacting, resting on, or resting around them, or it can be in indirect communication by way of a transmission member, such as a rod or shaft, in which case the transmission member is in communication, most often direct communication, with the first set of bearings and optionally in communication with the the second set of bearings when a second set of bearings is used.

This configuration serves to reduce the friction between the roll or core and the dispenser. As a result, the tension needed to rotate the roll and unwind the material from the roll is reduced so that the tension activated expandable sheet material will not tear as it unwinds. While the specific tension that is required will depend on the nature of the tension activated expandable sheet material, in many cases the tension required to unwind the roll of tension activated expandable sheet material (in units of N/m) is no more than 50, such as no more than 40, no more than 30, no more than 25, or even no more than 20, in all cases as measured by the test described herein.

Any type of bearing can be used as the bearing in the first set or, when employed, the second set of one or more bearings. Examples include mechanical bearings, such as one or more ball bearing, angular contact ball bearing, multiple row ball bearing, roller bearing, tapered roller bearing, plane bearing, or bushings. It is also possible to create bearings by coating surfaces with a low-friction coating to reduce the friction between the support structure and the roll or inner core member, thus lowering the resistance needed to unwind the tension activated expandable sheet material roll. Typical low friction coatings comprise one or more of polytetrafluoroethylene (PTFE), blends of PTFE and olefinic polymers, polyoxymethylene, molybdenum disulfide, or tungsten disulfide. This coating is optional and is not required in most cases because mechanical bearings, such as those listed above, are employed more frequently than low friction coatings in the dispensers described herein.

Typically, when more than one bearing is used in the first set of one or more bearings, all the bearings in the first set of one or more bearings are of the same type. This is not, however, required. Typically, when more than one bearing is used in the second set of one or more bearings, all the bearings in the second set of one or more bearings are of the same type. This is not, however, required. Also, most commonly the type of bearing used in the first set is the same as that used in the second set; however, this is also not required and will depend on the desired operating parameters of the dispenser and on the nature, size, and mass of the tension activated expandable sheet being employed.

The first and, optionally, second support members, as well as the bearings, are most commonly of metal, such as sheet metal for the first and second support members, but this is not required. Other materials such as plastics, cardboard, and the like, can also be used. Further, the first and second support members can be integral or non-integral.

In some cases, the bearings provide coefficient of friction that is no greater than 0.1, and optionally 0.05 to 0.1.

The use of bearings to reduce friction allows the dispensing of low-force tension activated expandable sheet materials. For example, many useful materials can be made by cutting expandable slit patterns, such as those described herein, into paper or other materials (such as thin plastic or metal sheets) that can readily be torn. When made with common paper stock and mounted on a dispenser as described herein, typically, these materials have a Minimum Pull Force Per Unit Width of 10 N/m to 23 N/m, such as 10 N/m10 N/m, 12 N/m, 15 N/m, 17 N/m, 20 N/m or even 22.5 N/m of force per unit width (wherein the width is the width of the sheet in the direction perpendicular to the direction that the sheet is wound or unwound) to deploy. Thus, they will typically deploy when a force of 3-7 N, such as 3 N, 3.5 N, 4 N, 4.5 N, 5 N, 5.5 N, 6 N, 6.5 N, or even 7 N is applied to a 305 mm wide roll, which corresponds (for a 305 mm wide roll) to 9.8-22.9 N/m. Materials of this type typically start to tear when 8.5 N, 9 N, 9.5 N, 10 N, 10.5 N, or even 11 N of force are applied to a 305 mm wide sample, which corresponds to 28.5-35.0 N/m. For such exemplary materials, it is desirable to have the Minimum Pull Force Per Unit Width be less than the tear force per unit width, i.e., less than 35.0 N/m.

In some cases, a force that may tear the tension activated expandable sheet material while unrolling the roll is lower than the Minimum Pull Force Per Unit Width. This can happen when, for example, the user holds only a small portion of the tension activated expandable sheet material and concentrates the pulling force for unrolling the roll on that small portion. In that case, the force required to rotate the roll must be borne only by the small portion of material, which may cause it to tear. As such, in some cases it is advantageous for the dispenser to provide a resistance per unit width of the roll that is much lower than the Minimum Pull Force Per Unit Width.

In many cases, the first set of bearings, and if employed the second set of bearings, will have a coefficient of friction with the roll, inner core, or transmission member, that provides a resistive force per unit width that equal too less than the Minimum Pull Force Per Unit Width. A lower resistive force per unit width may be particularly useful when an adjustable resistance system, such as those described herein, is employed can be used to further increase and fine-tune the resistive force to be at or greater than the Minimum Pull Force Per Unit Width without exceeding a resistance at which the tension activated expandable sheet material will tear when the roll is unwound. Typically, a coefficient of friction no greater than 0.1, and optionally 0.05 to 0.1 will provide an appropriate resistive force. By comparison, simply resting a paper interior core member on a metal support member, without the use of a first or second set of bearings, typically provides a coefficient of friction of 0.2-0.6, which in turn can produce a Minimum Pull Force Per Unit Width that is greater than the force that will cause the tension activated expandable sheet material to tear.

It should be noted that the particular values provided herein for forces, coefficients of friction, and related parameters are not required in all cases, and different parameters may be employed when appropriate, such as when needed to provide a Minimum Pull Force Per Unit Width that will unwind the roll without tearing the tension activated expandable sheet material. This is because the Minimum Pull Force Per Unit Width as well as the force at which the tension activated expandable sheet material tears will depend on the nature of the material, such as the material's constituents, as well as the slit pattern that is employed. Further, the Minimum Pull Force Per Unit Width also varies depending on the mass of the roll of tension activated expandable sheet material. While the parameters as described herein will appropriate in many cases, they are to understood as starting points and guidelines from which the skilled artisan, following the guidance of this disclosure, could readily determine appropriate parameters for any particular roll of tension activated expandable sheet material.

The tension activated expandable sheet typically comprises paper, but it can comprise or be other sheet materials such as plastic, foam, nonwoven, or the like. Similarly, the inner core member, which is usually but not necessarily a hollow cylinder, is usually made of paper such as cardboard, but could also be made of plastic, metal, or the like. Tension activated expandable sheet materials have a plurality of slits or cuts through the sheet. The plurality of slits or cuts are typically arranged in one or more repeating patterns on the sheet. Tension activated expandable sheet materials are defined by a tension axis and an axis orthogonal to the tension axis. The tension axis is typically the axis along which a roll of tension activated expandable sheet material is wound or unwound. When sufficient tension is applied along the tension axis of a tension activated expandable sheet material, the sheet expands in the direction of the tension axis.

In principle, any slit pattern that allows the tension activated expandable sheet to expand in a tensioning direction (e.g., the direction of unwinding) can be used. One example of a slit patterns that can be employed is disclosed in U.S. Pat. No. 9,533,809. Additional articles with patterned slits are described in PCT Patent Application Numbers IB2020/062065, IB2020/062048, IB2020/062149, IB2020/062061, IB2020/062294, and IB2020/062297.

Exemplary slit patterns may include flaps and/or folding wall shapes that allow portions of the slit patterns to rotate into positions that are nearly orthogonal (particularly 70° to 110°, more particularly 80° to 100°, and most particularly 85° to 95°), or even orthogonal (particularly, substantially 90°, wherein substantially means having the same physical properties as if the angle were exactly 90°, or more particularly 90°) to the plane of the original sheet when exposed to tension along the tension axis. The rotation of the material out of the plane of the sheet of material advantageously creates interlocking features that allow multiple layers of the expanded material to remain in place when wrapped around an object. Additionally, some of these embodiments can withstand exposure to greater loads applied in the normal axis relative to other patterned structures without being crushed. This means that they can provide increased or enhanced protection for items like packages being shipped and other applications.

Slits in the tension activated expandable sheets can be characterized as “simple slits” or “compound slits,” where a “simple slit” is defined as having exactly two terminal ends and a “compound slit” has more than two terminal ends. In some embodiments, the tension-activated, expanding articles include compound slits having more than two terminal ends, at least two slit segments, and at least one segment intersection.

Some embodiments include tension activated expandable articles and materials that having multi-slit patterns, A multi-slit pattern includes any slit pattern wherein two or more slits a set of different, directly adjacent rows substantially align with one another such that their terminal ends substantially align, but the terminal ends of the slits in one such set do not align with the terminal ends slits in a directly adjacent set of slits. In further embodiments, the slit pattern includes one or more multibeam slits. Multibeam slits are one or more simple slits that are formed between two adjacent simple or multi-slits in a pattern of simple or multi-slits, When a tension activated expandible sheet with multibeam slits is tension-activated a distinct extended pattern with one or more rotated multibeams is formed.

When employed, the interior core member typically comprises, or particularly is, paper. However, it can also comprise or be other materials, such as plastic, metal, and the like. The nature of the interior core member can vary because the use of bearings reduces the friction so that it is not necessary to select an interior core member that will provide a particular minimum or maximum friction as the roll unwinds.

When an interior core member is used, the interior core member is most commonly in direct communication with, such as by resting on, the first and second set of one or more bearings.

An interior core is not required and is not employed in many embodiments. It is possible to use a roll of expandable sheet material with no core, in which case the roll of expandable sheet material typically has a void or opening in the center which can be used to mount the roll of expandable sheet material in or on the dispenser. It is possible to make coreless rolls of tension activated expandable sheets either by winding or rolling the tension activated expandable sheets corelessly, or by winding or rolling them around a core and then removing the core.

For example, the void in the center of a coreless roll can be mounted on a transmission member. Suitable transmission members can be in the form of a rod or shaft, typically but not necessarily in a generally cylindrical shape, and optionally having an adjustable width or diameter to accommodate different roll dimensions. Other forms of transmission members include tabs, rollers, wheels, screws, and the like. The transmission member can be adjacent to or communicate with either the outside diameter of the roll or with the inside diameter of the roll. For example, the outside diameter of the roll can be supported by transmission members that are in the form of rollers, wherein the transmission members (rollers) are in turn supported by a first and optionally second set of bearings. Alternatively, the transmission member can be in the form of a rod or shaft that is inserted into the inside diameter of the roll and/or the inside diameter of a core (if a core is employed). Even in cases where the roll has no core, a transmission member is not required. It is possible, for example, to omit a transmission member and place the roll, with or without a core, directly on the first and or second set of bearings. It is also possible to use a transmission member in conjunction with a roll having an interior core.

In some cases, the low resistance and friction that is facilitated by the bearings can be too low such that the tension activated expandable sheet does not expand when the roll is unwound. This most often occurs when the roll is partly unwound, because the roll loses mass as it is unwound and the roll material (the tension activated expandable sheet) is removed from the roll. The reduction in mass in turn results in a lower normal force between the interior core member and the bearings, and thus a lower resistance to unwinding.

In cases where the resistance is too low, it is possible to include an adjustable resistance system, most commonly one that is configured to apply an adjustable resistance to one or more of the roll, the interior core member, the transmission member, or the one or more sets of bearings. When employed, the adjustable resistance system can take any suitable form. Examples include a friction belt, friction plate or friction brush. Optionally, these contact one or more of the roll, the interior core member, the transmission member, or the one or more sets of bearings to apply an adjustable pressure thereto. The pressure can be desirably controlled by a force regulating element such as a clamp, vice, screw, cam, or lever. The pressure can be adjusted by tightening or loosening the force regulating element. The adjustable resistance system can include a spring element between the friction element and the clamp, vice, screw, cam or lever to help regulate the force.

In use, the roll of tension activated sheet material will typically comprise a free end that is available to be pulled. Tension is applied to the free end, at least part of the tension being in a tensioning direction of the tension activated expandable sheet (i.e., the direction in which, when tension is applied, the tension activated expandable sheet will expand). This tension unrolls at least a portion of the tension activated expandable sheet material from the roll. Typically, the tension activated expandable sheet material is expanded as it comes off the roll, simultaneously with it being unwound.

In some cases, it can be desirable to maintain a tension that is reasonably constant within the range that will unwind and expand the tension activated expandable sheet material without tearing it. This can be accomplished by including an adjustable resistance system as described herein. When an adjustable resistance system is used, the method can also comprise adjusting the resistance exerted on the roll or inner core member by the adjustable resistance element when doing so is necessary to maintain a resistance that is low enough not to tear the tension activated expandable sheet material but high enough to expand the material as it unwinds from the roll.

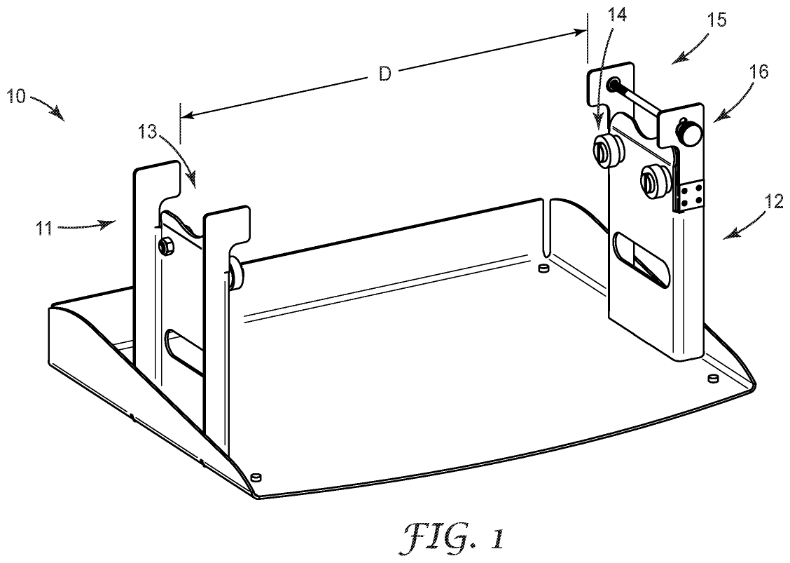

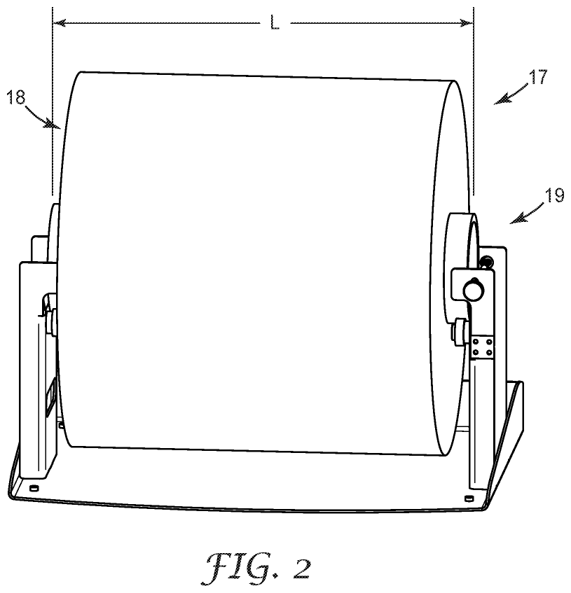

Turning to the figures which, being drawn for primarily for clarity and to illustrate certain features of the disclosure, are not necessarily to scale, FIG. 1 and FIG. 2 show dispenser 10. In FIG. 1 it is depicted without the roll of tension activated expandable sheet material, whereas FIG. 2 shows it with roll 17 of tension activated expandable sheet material 18 wound around inner core member 19 which has axial length L. First support 11 and second support 12 are spaced apart at distance D which is at least as great, and in FIGS. 1 and 2 greater, than axial length L of inner core member 19. First set of bearings 13 is associated with first support 11 but not with second support 12, and second set of bearings 14 is associated with second support 12 but not with first support 11. In FIG. 1 and FIG. 2 there are two bearings in each set, but these figures are merely illustrative number can vary. Clamp 15 is configured to apply, if desired, pressure on inner core member 19 when clamp 15 is tightened with screw 16. By doing so, the resistive force can be adjusted if desired.

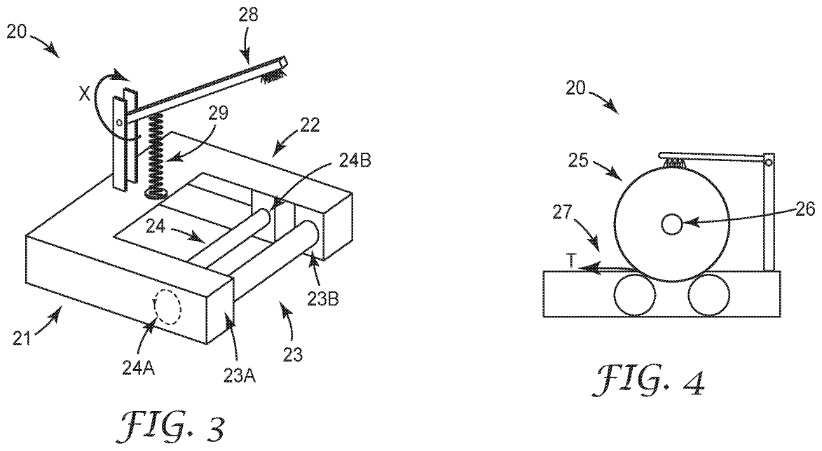

FIG. 3 and FIG. 4 shows a different configuration of a device 20 having first and second support members 21, 22 and first and second sets of one or more bearings 23. In this configuration, a transmission member that includes two rollers 23, 24 is present. Roller 23 interacts with first set of two bearings, 23A, 23B, and roller 24 interacts with second set of two bearings, 24A, 24B. Both the of bearings 23A, 23B and the second set of bearings 24A, 24B, contain bearings that are associated with the first support member 21 and the second support member 22.

Roll 25 has inner core member 26, but in this configuration roll 25 sits directly the transmission member (i.e., rollers 23, 24). Free end 27, when tensioned in tensioning direction T, can unwind the roll and expand the tension activated expandable sheet material simultaneously. Brush 28, which communicates with torsion spring 29, is used as an adjustable resistance system, specifically an adjustable friction device, to add resistance by applying pressure to roll 25. The resistance can be set based on the selection of a spring 29 with desired properties. Because the torque provided by the spring is essentially constant through its motion, and the brush is contacting the outer surface of the roll, the tension resistance provided to the free end 27 will be essentially constant for any diameter of the roll.

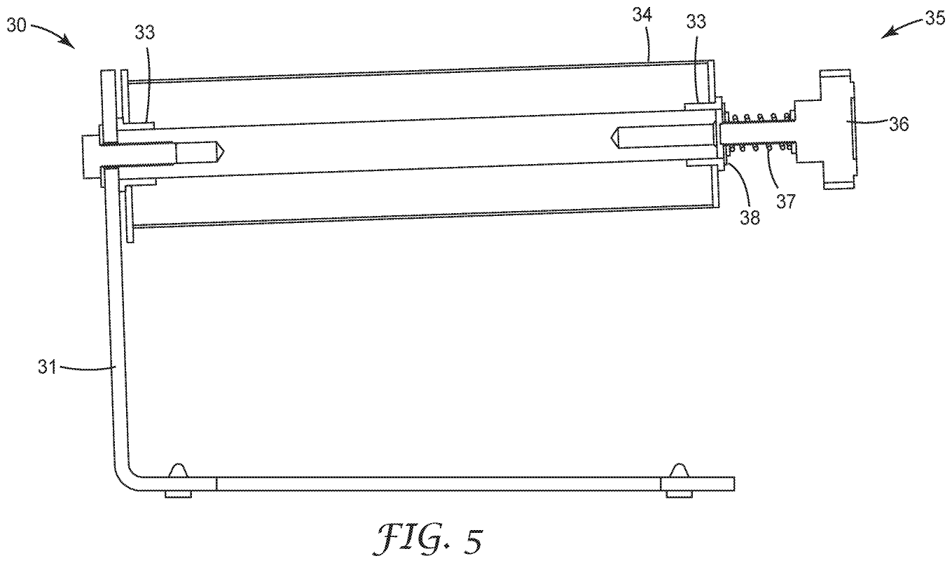

FIG. 5 shows device 30, having a first support member 31, and a first set of bearings 33. In this configuration, the first set of bearings 33 has two bearings associated with both the first support member and the transmission member 34, which here is in the form of a shaft. Transmission member 34 is configured to serve as a mount for a roll of tension activated expandable sheet material (not shown). Transmission member 34 can rotate to dispense the tension activated expandable sheet material from the roll. Use of transmission member 34 is particularly well suited to coreless rolls, in which case the void in the roll is used to mount the roll on transmission member 34; however it can also be used with rolls having an interior core in which case a void in the interior core can be used to mount transmission member 34. Adjustable resistant system 35 includes a threaded knob 36, spring 37, and low friction washer 38. When the knob 36 is tightened, it increases the axial load on the bearings 33, increasing their resistance to rotation, which in turn can increase the tension required to unwind the roll to ensure that the tension activated expandable sheet expands as it unwinds from the roll.

Minimum Pull Force Per Unit Width

The Minimum Pull Force Per Unit Width can be thought of as the minimum tension per width of a sheet (the width being the dimension perpendicular to the direction in which the sheet is rolled) that is required to unroll a roll of tension activated expandable sheet material that is at rest. In this disclosure, the minimum tension required to unwind a roll of tension activated expandable sheet material on a dispenser is determined by the following procedure:
1) Load the dispenser with a full roll of tension activated expandable sheet material. Any tape or adhesive that may be affixing the free end of the roll to the remainder of the roll must be removed. The free end of the roll should be orthogonal (+/−5 degrees) to the direction in which the roll is wound.
2) To outside of the free end of the roll, attach a 15# monofilament fishing line (such as that available under the trade name Berkley Trilene Super Strong) with tape, such as tape available from 3M Company (St. Paul, Minn., USA) under the trade designation 3M 3939 Duct Tape. So long as the tape does not detach from the roll during the test and the combined mass of the tape and the fishing line is no more than 0.1% of the mass of the roll (e.g., for an 11 kg roll, the maximum combined mass of fishing line and mass of tape that may be used is 11 g), the precise nature of the tape will not alter the result beyond the experimental error. The attachment point of the fishing line to the roll should be within 5 cm of the end of the roll and in the center of the width of the roll. The tape is to be placed parallel (+/−5 degrees) to the free end of the roll, centered on the fishing line, and extending to at least 20% but no more than 90% of the width of the roll. The fishing line is then wrapped around the roll three times in the direction in which the roll is wound. The length of the fishing line must be sufficient to be wrapped around the roll as described in this step and to be configured as described in step 3, but the precise length will not appreciably alter the results so long as the combined mass requirements of the fishing line and tape, as described in this step, are met.
3) Route the free end of the fishing line so it can hang free straight down, in the direction of gravity. In certain configurations of the dispenser, it may be necessary to rest the dispenser on two surfaces with a gap between them to allow the fishing line to hang free and not be obstructed by the work surface. In certain configurations of the dispenser, it may be necessary to drill a hole in the bottom or base of the dispenser to allow the fishing line to hang free. These or similar manipulations are valid and, when necessary to achieve the required position of the cable, required in this test.
4) Carefully and slowly attach a standard calibration weight to the free end of the cable such that the weights do not contact the roll, the dispenser, or any other surface. Add additional standard calibration weights in increments until the roll just starts to move.
5) The lowest weight that just starts the roll to turn is the minimum pull force. If the weights are standardized by their mass (e.g. g or kg) rather than weight (e.g., Newtons or pounds), then the minimum pull force is calculated by multiplying the mass by the gravitational constant.
6) Minimum Pull Force Per Unit Width is calculated by dividing the minimum pull force from step 5 by the width of the roll of tension activated expandable sheet material.

1. An article for dispensing tension activated expandable sheets, comprising
a roll of tension activated expandable sheet material having a plurality of slits;
a first support member;
a first set of one or more bearings associated with at least the first support member; wherein
the roll is in communication with the first set of bearings.

2. The article of claim 1, further comprising a second support member opposing the first support member and a second set of one or more bearings associated with at least the second support member, wherein the roll or the interior core is in communication with the first and second sets of bearings.

3. The article of claim 1, wherein the roll of tension activated expandable sheet material further comprises an inner core member, and optionally wherein the inner core member is in direct communication with the first set of bearings.

4. (canceled)

5. The article of claim 1, wherein the roll of tension activated expandable sheet material is a coreless roll.

6. The article of claim 1, wherein the core interior member has an axial length, and
further comprising a distance that separates the first support member from the second support member, wherein
the distance that separates the first support member from the second support member is no less than the axial length of the core interior support member, and optionally greater than the axial length of the core interior support member

7. The article of claim 1, wherein the article further comprises a transmission member and wherein the roll, interior core member, or both communicate with the first set of bearings, and optionally with the second set of bearings, through the transmission member

8. The article of claim 1, wherein the first set of bearings and optimally the second set of bearings are in direct communication with the inner core member or the roll.

9. (canceled)

10. The article of claim 1, wherein the first set of bearings is associated with both the first and second support members, and optionally wherein the second set of bearings is associated with both the first and second support members.

11. The article of claim 1, wherein the first set of bearings is associated with the first support member but is not associated with the second support member, and optionally wherein the second set of bearings is associated with the second support member but is not associated with the first support member.

12. The article of claim 1, wherein the first set of bearings comprises one or more ball bearing, angular contact ball bearing, multiple row ball bearing, roller bearing, tapered roller bearing, plane bearing, or bushings, and optionally wherein the second set of bearings independently comprises one or more ball bearing, angular contact ball bearing, multiple row ball bearing, roller bearing, tapered roller bearing, plane bearing, or bushings.

13. The article of claim 1, wherein at least one of the first and second sets of bearings comprises a low-friction coating, the low-friction coating optionally comprising one or more of polytetrafluoroethylene (PTFE), blends of PTFE and olefinic polymers, polyoxymethylene, molybdenum disulfide, or tungsten disulfide.

14. The article of claim 1, wherein the coefficient of friction between the first support member and the roll, the interior core membrane, or the transmission member is no greater than 0.1, and optionally 0.05-0.1.

15. The article of claim 1, wherein the tension activated expandable sheet material comprises paper.

16. The article of claim 1, wherein the interior core member comprises paper.

17. The article of claim 1, further comprising at least one adjustable resistance system that is configured to contact and apply and adjustable pressure to one or more of the roll, the interior core, and the transmission member.

18. The article of claim 17, wherein the adjustable resistance element comprises a clamp, vice, screw, cam, or lever.

19. The article of claim 17, wherein the adjustable resistance element comprises a brush or roller in communication with a spring to provide a resistance tension that self-adjusts as the size of the roll changes.

20. A method of dispensing a tension activated expandable sheet material from a dispenser of any of the preceding claims;
wherein the tension activated expandable sheet material comprises a free end;
the method comprising:
applying tension to the free end, at least a part of the tension being in a tensioning direction of the tension activated expandable sheet material; and
unrolling at least a portion of the tension activated expandable sheet material from the roll.

21. The method of claim 20, wherein the step of unrolling at least a portion of the tension activated expandable sheet material from the roll comprises simultaneously expanding at least some of the tension activated expandable sheet material.

22. The method of claim 20, wherein the method further comprises adjusting the resistance tension by adjusting at least one element of an adjustable resistance system.
